(19) United States
(12) Patent Application Publication
(10) Pub. No.: US 2009/0106833 A1
(43) Pub. Date: Apr. 23, 2009

(54) ELECTRONIC APPARATUS WITH PERIPHERAL ACCESS MANAGEMENT SYSTEM AND METHOD THEREOF

(75) Inventors: SHIH-FANG WONG, Tu-Cheng (TW); YI-FENG WENG, Shenzhen City (CN); WEN-WU WANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/177,842

(22) Filed: Jul. 22, 2008

(30) Foreign Application Priority Data
Oct. 23, 2007 (CN) 200710202208.1

(51) Int. Cl. H04L 9/32

(52) U.S. Cl. 726/18; 726/17

(57) ABSTRACT

A method for managing access authorization of peripherals of an electronic apparatus is provided. The method includes the step of: providing a data storage for storing a peripheral registry table which stores hardware IDs of the peripherals; reading the hardware ID of the peripheral when the peripheral is connected to the electronic apparatus; determining whether the hardware ID is recorded in the peripheral registry table; activating an access of the peripheral when the hardware ID is recorded in the peripheral registry table; and registering the hardware ID of the peripheral into the peripheral registry table when the hardware ID is not recorded in the peripheral registry table.

### BACKGROUND

1. Field of the Invention

The present invention relates to an electronic apparatus with a peripheral access management system and method for managing access authorization of peripherals.

2. Description of the Related Art

In order to ensure data security of computers, data security control systems, such as setting authorizations for a user to access data stored in the computer, are adopted. The data security control systems have been implemented in software form either as part of a computer's operating system or as specific application software. However, the reliability of software implementation of data security control system can often be compromised. It is difficult to design and implement reliable and robust data security software.

Therefore, what is needed is an electronic apparatus and method that provides better data security management.

### SUMMARY

An electronic apparatus with an access authorization management function for peripherals is provided. The electronic apparatus includes a data storage, an authorized peripheral determining module, an access authorization management module, and a peripheral registering module. The data storage is for storing a peripheral registry table for recording hardware IDs of the peripherals of the electronic apparatus. The authorized peripheral determining module is for reading the hardware ID of a peripheral when the peripheral is connected to the electronic apparatus and determining whether the hardware ID is recorded in the peripheral registry table. The access authorization management module is for allowing use of the peripheral when the hardware ID is recorded in the peripheral registry table. The peripheral registering module is for registering the hardware ID of the electronic apparatus in the peripheral registry table when the hardware ID is not recorded in the peripheral registry table.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of the electronic apparatus. Moreover, in the drawings, like reference numerals designate corresponding parts throughout several views.

FIG. 1 is a block diagram of an electronic apparatus with a peripheral access management system in accordance with an exemplary embodiment of the present invention.

FIG. 2 is a flowchart of a method for managing peripheral access authorization by the electronic apparatus of FIG. 1.

### DETAILED DESCRIPTION OF THE EMBODIMENTS

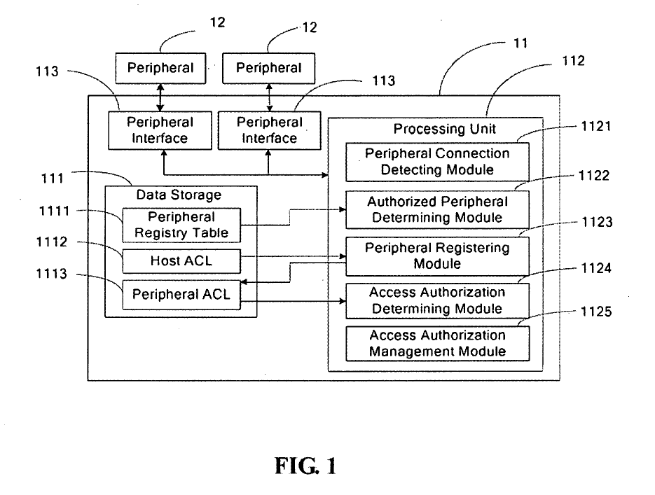

FIG. 1 is a block diagram of an electronic apparatus with a peripheral access management system (hereinafter “the apparatus”) in accordance with an exemplary embodiment of the present invention. The apparatus includes a host 11 and a plurality of peripherals 12. The peripherals 12 include, but are not limited to, a keyboard, a display, and a sound box. The host 11 includes a data storage 111, a processing unit 112, and a plurality of peripheral interfaces 113. The peripherals 12 connect to the host 11 via the corresponding peripheral interfaces 113. The data storage 111 includes a peripheral registry table 1111, a host access control list (ACL) 1112, and a peripheral ACL 1113. The peripheral registry table 1111 is configured for recording hardware IDs (identifiers) of the peripherals 12. The peripheral registry table 1111 includes a peripheral column and a hardware ID column. Each entry under the peripheral column records the name of the peripheral 12 that is recorded in the peripheral registry table 1111. Each entry under the hardware ID column records corresponding hardware ID of each recorded peripheral 12. The hardware ID is configured for identifying the peripheral 12.

Peripheral Registry Table

| Peripheral | Hardware ID |
|---|---|
| Keyboard 1 | XXXXXXX1 |
| Keyboard 2 | XXXXXXX2 |
| Mouse 1 | XXXXXXX3 |
| Mouse 2 | XXXXXXX4 |

The host ACL 1112 is configured for determining access authorization to the host 11 for registered users. The host ACL includes an account column and a password column. Each entry under the account column records the access accounts of each authorized user. Each entry under the password column records a corresponding password of each access account.

Host ACL

| Account | Password |
|---|---|
| John | XXXXXXX |
| Heaven | XXXXXXX |
| Rose | XXXXXXX |
| Sheep | XXXXXXX |

The peripheral ACL 1113 is configured for recording access passwords of the peripherals 12. The peripheral ACL includes an account column, a hardware ID column, and a password column. Each entry under the account column records the access account to the host 11 of each user and is the same as that in Host ACL 1112. Each entry under the hardware ID column records the hardware ID of each peripheral 12 of the apparatus. Each entry under the password column records a corresponding password of each peripheral 12. The users set the password of each peripheral 12 according to the access account.

Peripheral ACL

| Account | Hardware ID | Password |
|---|---|---|
| John | XXXXXXX | 134568 |
| | XXXXXXX | 756219 |
| | XXXXXXX | 563218 |
| | XXXXXXX | 773256 |
| Heaven | . . . | . . . |
| . . . | . . . | . . . |

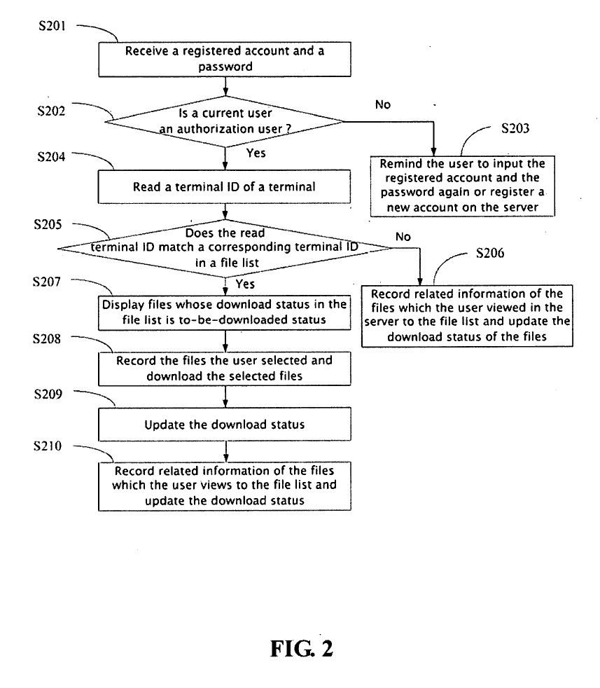

The processing unit 112 includes a peripheral connection detecting module 1121, an authorized peripheral determining module 1122, a peripheral registering module 1123, an access authorization determining module 1124, and an access authorization management module 1125. Reference can be made to FIG. 2 for functions implemented by these modules of the processing unit 112.

FIG. 2 is a flowchart of a method for managing access authorization of the peripherals 12. In step S201, the peripheral connection detecting module 1121 detects whether there is an unidentified peripheral X connected to a peripheral interface 113.

If there is a peripheral X connected to a peripheral interface 113, in step S202, the authorized peripheral determining module 1122 reads the hardware ID of the peripheral X.

In step S203, the authorized peripheral determining module 1122 searches for a match to the hardware ID of the peripheral X in the peripheral registry table 1111 to determine whether the hardware ID exists in the peripheral registry table 1111.

If the hardware ID of the peripheral does not exist in the peripheral registry table 1111, in step S204, the peripheral registering module 1123 generates a dialog box to prompt the user to input their access account name and corresponding password.

In step S205, the peripheral registering module 1123 determines whether the input access account exists in the host ACL 1112. If the input access account exists in the host ACL 1112, the peripheral registering module 1123 further determines whether the input password matches the password corresponding to that access account in the host ACL 1112.

If the input access account does not exist in the host ACL 1112 or the input password of the user does not match the corresponding password of the access account in the host ACL 1112, in step S206, the peripheral registering module 1123 informs the user that the account does not exist or the password is incorrect and the access authorization management module 1125 prohibits access to or of the peripheral X. The way of prohibiting access to or of peripherals may differ according to the type of peripheral. For example, if the peripheral X is a display, the access authorization management module 1125 controls the display to display in a black screen form and a dialog box prompting the user to input a password. If the peripheral X is a keyboard, the access authorization management module 1125 only accepts a correct password input through the keyboard and nothing else. If the peripheral X is a mouse or sound box, the access authorization management module 1125 prohibits the corresponding peripheral interface 113 to transmit data. However, it should be noted that the way of prohibiting access of or to a peripheral X is not limited to the description described above.

If the input access account exists in the host ACL 1112 and the input password of the user matches the corresponding password of the access account in the host ACL 1112, In step S207, the peripheral registering module 1123 prompts the user to register the hardware ID of the peripheral X. If the user does not choose to register the hardware ID of the peripheral X, the procedure goes to step S206.

If the user chooses to register the hardware ID of the peripheral X, in step S208, the peripheral registering module 1123 registers the hardware ID of the peripheral X in the peripheral register table 1111 and sets an access password for the peripheral X, which becomes an identified peripheral 12, corresponding to the access account in the Peripheral ACL 1113.

In step S209, the access authorization management module 1125 activates access to or of the peripheral 12.

If the authorized peripheral determining module 1122 determines that the hardware ID of the peripheral exists in the peripheral registry table 1111 by step S203, in step S210, the access authorization determining module 1124 generates a dialog box to prompt the user input the access account and access password of the now identified peripheral 12.

In step S211, the access authorization determining module 1124 determines whether the input access account and password of the user matches the access account and password corresponding to the hardware ID in the Peripheral ACL 1113. If the input access account and password of the user matches the access account and password corresponding to the hardware ID in the Peripheral ACL 1113, the procedure goes to step S209.

If the input access account and password of the user does not match the access account and password corresponding to the hardware ID in the Peripheral ACL 1113, in step S212, the access authorization determining module 1124 informs the user that the input password is wrong, and the access authorization management module 1125 prohibits access to or of the peripheral 12.

Although the present invention has been specifically described on the basis of preferred embodiments, the invention is not to be construed as being limited thereto. Various changes or modifications may be made to the embodiment without departing from the scope and spirit of the invention.

What is claimed is:

1. An electronic apparatus with an access authorization management function on peripherals, comprising:
a data storage for storing a peripheral registry table which records hardware IDs (identifier) of the peripherals of the electronic apparatus;
an authorized peripheral determining module for reading the hardware ID of one of the peripherals when the peripheral is connected to the electronic apparatus, determining whether the hardware ID is recorded in the peripheral registry table;
an access authorization management module for activating an access of the peripheral when the hardware ID is recorded in the peripheral registry table; and
a peripheral registering module for registering the hardware ID of the peripheral into the peripheral registry table when the hardware ID is not recorded in the peripheral registry table.

2. The apparatus as described in claim 1, wherein the apparatus further comprises an access authorization determining module, the data storage further stores a peripheral access control list (ACL) which records access passwords of the peripherals, and the access authorization determining module is capable of promoting a user to input access password of the peripheral if the hardware ID is recorded in the peripheral registry table, and informing the access authorization management module to activate the access of the peripheral if the password input by the user matches the access password recorded in the peripheral ACL.

3. The apparatus as described in claim 2, wherein the access authorization management module is further capable of prohibiting the access of the peripheral if the password input by the user does not match the access password recorded in the peripheral ACL.

4. The apparatus as described in claim 2, wherein the peripheral registering module is further capable of setting the access password for the peripheral and storing the access password to the peripheral ACL.

5. The apparatus as described in claim 1, wherein the apparatus further comprises an access authorization determining module, the data storage further stores a host ACL, the host ACL records the access accounts and passwords of the host and the access authorization determining module is for promoting the user to input the access account and passwords of the host when the hardware ID of the peripheral is not recorded in the peripheral registry table, and recording the hardware ID in the peripheral registry table when the access account and the password input by the user match the access account and password recorded in the host ACL.

6. The apparatus as described in claim 5, wherein the access authorization management module is further capable of prohibiting the access of the peripheral if the access account and the password input by the user does not match the access account and password recorded in the host ACL.

7. A method for managing access authorization of peripherals of an electronic apparatus, comprising:
providing a data storage for storing a peripheral registry table which stores hardware IDs of the peripherals;
reading the hardware ID of one of the peripherals when the peripheral is connected to the electronic apparatus;
determining whether the hardware ID is recorded in the peripheral registry table;
activating an access of the peripheral when the hardware ID is recorded in the peripheral registry table; and
registering the hardware ID of the peripheral into the peripheral registry table when the hardware ID is not recorded in the peripheral registry table.

8. The method as described in claim 7, further comprising promoting a user to input an access password of the peripheral when the hardware ID is recorded in the peripheral registry table, and then activating the access of the peripheral if the password input by the user matches to an access password which records in a peripheral ACL in the data storage, the peripheral ACL records access passwords of the peripherals.

9. The method as described in claim 8, further comprising prohibiting the access of the peripheral if the password input by the user does not match the access password recorded in the peripheral ACL.

10. The method as described in claim 8, further comprising setting the access password for the peripheral, and storing the access password in the peripheral ACL.

11. The method as described in claim 7, further comprising reminding the user to input the access account and password of the host when the hardware ID of the peripheral is not recorded in the peripheral registry table, and recording the hardware ID in the peripheral registry table when the access account and password input by the user match the access account and password recorded in a host ACL, the host ACL records the access accounts and passwords of the host.

12. The method as described in claim 11, further comprising prohibiting the access of the peripheral if the access account and the password input by the user does not match the access account and password recorded in the host ACL.
